(19) United States
(12) Patent Application Publication
(10) Pub. No.: US 2006/0262206 A1
(43) Pub. Date: Nov. 23, 2006

(54) Noise reduction method

(75) Inventors: Wei-Kuo Lee, Zhubei City (TW); Yun-Hung Shen, Hsinchu City (TW); Ji-Wei Wan, Pingjhen City (TW)

Correspondence Address: BRUCE H. TROXELL, SUITE 1404, 5205 LEESBURG PIKE, FALLS CHURCH, VA, 22041, US

(73) Assignee: Mstar Semiconductor Inc.

(21) Appl. No.: 11/433,446

(22) Filed: May 15, 2006

Related U.S. Application Data
(60) Provisional application No. 60/682,407, filed on May 19, 2005.

(51) Int. Cl. H04N 5/217

(52) U.S. Cl. 348/241

(57) ABSTRACT

The present invention provides a noise reduction method for use in reducing noise of a digital image, the method comprising steps of: defining a target window on a coordinate plane defined by the first chrominance and the second chrominance as the horizontal axis and the vertical axis; determining a noise threshold value according to whether an input pixel having a first chrominance value and a second chrominance value is located inside the window; determining whether the input pixel is a noise point according to the noise threshold value and luminance values of neighboring pixels of the input pixel; and adjusting the luminance value of the input pixel if the input pixel is determined a noise point. Using the noise reduction method of the present invention, not only noise of a digital image can be identified, but also the degradation caused by the noise can be reduced and thus the overall picture quality can be improved.

### BACKGROUND OF THE INVENTION

1. Field of the Invention

The present invention generally relates to a noise reduction method and, more particularly, to a noise reduction method using the luminance value and the chrominance values of an input pixel so as to identify and eliminate a noise point of a digital image by adjusting the luminance value and the chrominance values.

2. Description of the Prior Art

In digital image processing, the most generally used method to reduce noise is to directly process the pixels related to the image. For example, averaging filters and sequence statistical filters are used according to respective requirements.

Conventionally, mosquito noise and Gaussian noise are eliminated using a lowpass filter, operating corresponding to the pixel values in a masked region by the filter so as to obtain a mean value and then make the mean value replace the pixel values. However, the lowpass filter performs pixel adjustment for the entire image including some non-noise portions. Therefore, the noise reduction process using the lowpass filter may lead to undesirable distortion of the image because it cannot identify where noise occurs. Moreover, since the pixel is adjusted according to the pixel values of the neighboring pixels, the adjusted image shows unnaturalness in luminance and chrominance.

Accordingly, the present invention provides a noise reduction method not only to identify noise of a digital image, but also to reduce noise by adjusting the luminance value and the chrominance values to avoid image distortion.

Compared to the prior art, the noise reduction method of the present invention exhibits excellent performance in noise reduction while remaining the original colors in the region where there is no noise determined.

### SUMMARY OF THE INVENTION

It is a primary object of the present invention to provide a noise reduction method so as to identify noise in a digital image and adjust the luminance value and the chrominance values of a pixel that is determined a noise point so that the image quality is improved and the image distortion is avoided.

In order to achieve the foregoing object, the present invention provides a noise reduction method, comprising steps of: defining a target window on a coordinate plane defined by the first chrominance and the second chrominance as the horizontal axis and the vertical axis; determining a noise threshold value according to whether an input pixel having a first chrominance value and a second chrominance value is located inside the target window; determining whether the input pixel is a noise point according to the noise threshold value and luminance values of neighboring pixels of the input pixel; and adjusting a luminance value of the input pixel if the input pixel is determined a noise point.

Preferably, a noise weighting calculation is performed according to the shortest distance between the target window and the input pixel so as to determine the noise threshold value if the input pixel having the first chrominance value and the second chrominance value is located inside the target window.

Preferably, the step of determining whether the input pixel is a noise point comprises steps of: obtaining a set of luminance difference values by calculating the difference values between the luminance value of each of the neighboring pixels of the input pixel and a mean luminance value of the neighboring pixels; and determining whether the input pixel is a noise point based on the comparison between the absolute value of each of the luminance difference values and the noise threshold value.

Preferably, the step of adjusting the luminance value of the input pixel comprises a step of: performing a luminance adjusting calculation so as to adjust the luminance value of the input pixel according to the luminance value of the input pixel and the mean luminance value of the neighboring pixels of the input pixel.

The present invention further provides a noise reduction method for use in reducing noise of a digital image, the method comprising steps of: defining a target window on a coordinate plane defined by the first chrominance and the second chrominance as the horizontal axis and the vertical axis; determining a noise threshold value according to whether an input pixel having a first chrominance value and a second chrominance value is located inside the target window; determining whether the input pixel is a noise point according to the noise threshold value and color values of neighboring pixels of the input pixel; and adjusting a color value of the input pixel if the input pixel is determined a noise point.

Preferably, a noise weighting calculation is performed according to the shortest distance between the target window and the input pixel so as to determine the noise threshold value if the input pixel having the first chrominance value and the second chrominance value is located inside the target window.

Preferably, the step of determining whether the input pixel is a noise point comprises steps of: obtaining a set of color difference values by calculating the difference values between the color value of each of the neighboring pixels of the input pixel and a mean color value of the neighboring pixels; and determining whether the input pixel is a noise point based on the comparison between the absolute value of each of the color difference values and the noise threshold value.

Preferably, the step of adjusting the color value of the input pixel comprises a step of: performing a color adjusting calculation so as to adjust the color value of the input pixel according to the color value of the input pixel and the mean color value of the neighboring pixels of the input pixel.

Accordingly, the present invention provides a noise reduction method using the first chrominance and the second chrominance values of an input pixel to select a noise threshold value and determine whether the input pixel is infected with noise, which is to be eliminated by adjusting the luminance value or the color value of the input pixel.

### BRIEF DESCRIPTION OF THE DRAWINGS

The objects, spirits and advantages of the preferred embodiments of the present invention will be readily understood by the accompanying drawings and detailed descriptions, wherein:

FIG. 1 is a schematic diagram showing an input pixel and its neighboring pixels according to the preferred embodiment of the present invention;

FIG. 2 is a schematic diagram showing an input pixel and a corresponding target window according to the preferred embodiment of the present invention;

FIG. 3 is a flowchart showing steps of the noise reduction method according to the preferred embodiment of the present invention;

FIG. 4 is a flowchart showing steps for adjusting the first chrominance value in the noise reduction method according to another preferred embodiment of the present invention;

FIG. 5 is a flowchart showing steps for adjusting the second chrominance value in the noise reduction method according to another preferred embodiment of the present invention; and

FIG. 6 is a lookup table used in the noise reduction method according to the present invention.

### DETAILED DESCRIPTION OF THE PREFERRED EMBODIMENT

The present invention providing a noise reduction method can be exemplified by the preferred embodiments as described hereinafter.

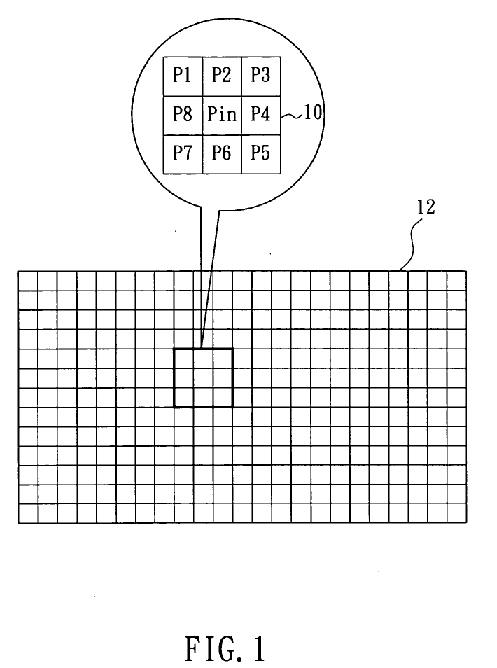

Please refer to FIG. 1, which is a schematic diagram showing an input pixel and its neighboring pixels according to the preferred embodiment of the present invention. A 3×3 mask 10 comprises an input pixel Pin and its neighboring pixels P1, P2, P3, P4, P5, P6, P7, P8. When the input pixel Pin moves from one point in a digital image 12 to another, the mask 10 also moves. The mask 10 can also be implemented by using a 5×5 mask or a 7×7 mask.

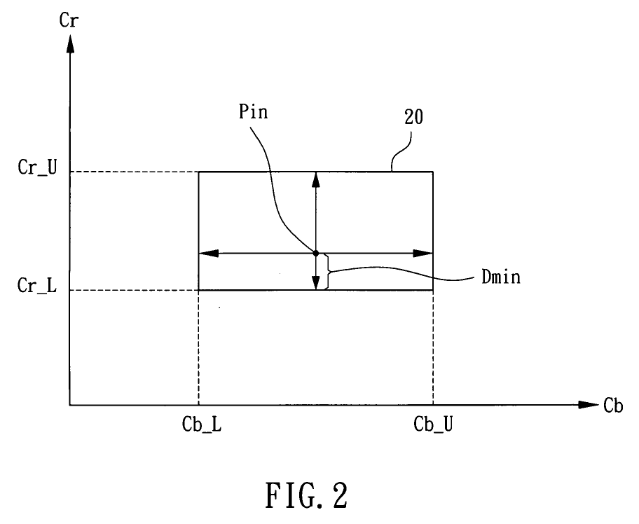

Please refer to FIG. 2, which is a schematic diagram showing an input pixel and a corresponding target window according to the preferred embodiment of the present invention. A target window 20 is established on a coordinate plane defined by the first chrominance Cb and the second chrominance Cr as the horizontal axis and the vertical axis. The target window 20 is a rectangular window, wherein Cb_U, Cb_L, Cr_U and Cr_L are determined by the user. There exists a shortest distance Dmin between the target window 20 and the input pixel Pin if the input pixel Pin having the first chrominance value Cb and the second chrominance value Cr is located inside the target window 20.

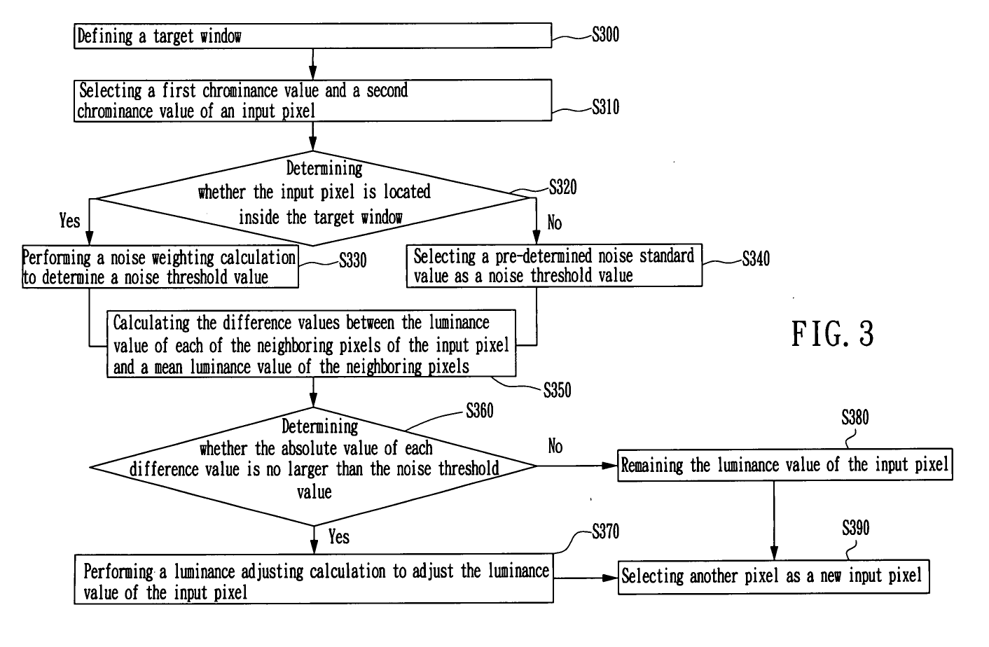

Please refer to FIG. 3, which is a flowchart showing steps of the noise reduction method according to the preferred embodiment of the present invention. First, as described in Step S300, a target window is defined on a coordinate plane defined by the first chrominance and the second chrominance as the horizontal axis and the vertical axis. In Step S310, a first chrominance value and a second chrominance value of an input pixel are selected. Then in Step S320, whether the input pixel having the first chrominance value and the second chrominance value is located inside the target window is determined.

In Step S330, a noise weighting calculation is performed to determine a noise threshold value if the input pixel having the first chrominance value and the second chrominance value is located inside the target window; otherwise, a pre-determined noise standard value is selected as a noise threshold value if the input pixel having the first chrominance value and the second chrominance value is not located inside the target window, as described in Step S340. The noise weighting calculation is expressed as:
N_{—}th=N_{—}b−W1×Dmin
wherein N_th is the noise threshold value, N_b is a pre-determined noise standard value, W1 is a first weighting value and Dmin is the shortest distance between the target window and the input pixel.

After the noise threshold value is determined, the difference values between the luminance value of each of the neighboring pixels of the input pixel and a mean luminance value of the neighboring pixels are calculated so as to obtain a set of luminance difference values, as described in Step S350. In Step S360, whether the absolute value of each difference value is no larger than the noise threshold value is determining. In Step S370, a luminance adjusting calculation is performed to adjust the luminance value of the input pixel if the absolute value of each difference value is no larger than the noise threshold value; otherwise, the luminance value of the input pixel is remained if the absolute value of any difference value is larger than the noise threshold value, as described in Step S380. The luminance adjusting calculation is expressed as:
Yin_new=(1−W2)×Yin+W2×Y_mean

wherein Yin_new is an adjusted luminance value of the input pixel, Yin is the luminance value of the input pixel, W2 is a second weighting value and Y_mean is a mean luminance value of the neighboring pixels of the input pixel.

After either Step S370 or Step S380 is completed, another pixel is selected as a new input pixel, as described in Step S390.

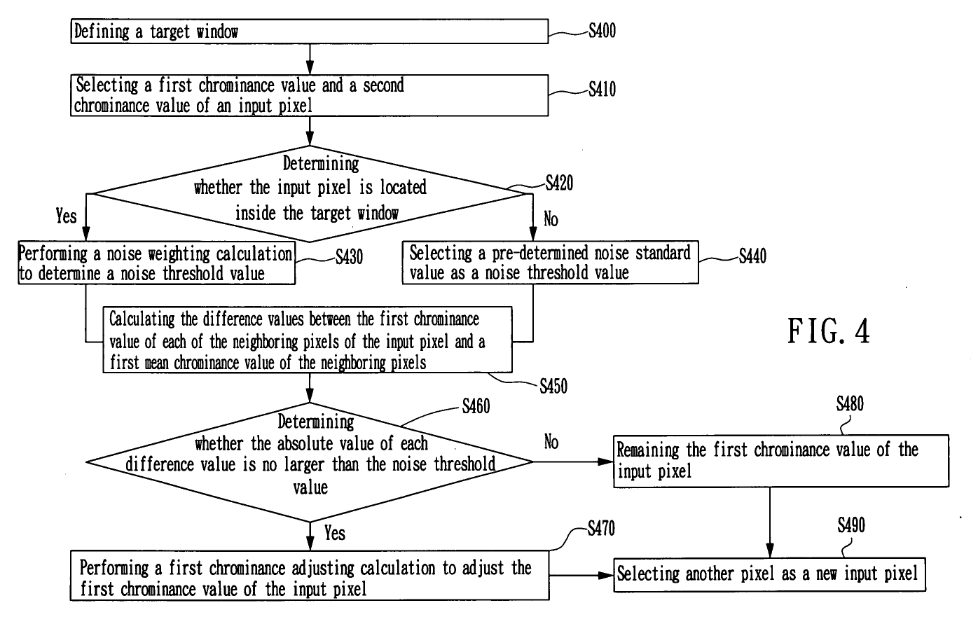

Please further refer to FIG. 4, which is a flowchart showing steps for adjusting the first chrominance value in the noise reduction method according to another preferred embodiment of the present invention. Step S400 to Step 440 are identical to Step S300 to Step 340. Step S450 to Step S480 are used for adjusting the first chrominance value, as described hereinafter.

In Step S450, the difference values between the first chrominance value of each of the neighboring pixels of the input pixel and a first mean chrominance value of the neighboring pixels are calculated so as to obtain a set of first chrominance difference values, as described in Step S450. In Step S460, whether the absolute value of each difference value is no larger than the noise threshold value is determining. In Step S470, a first chrominance adjusting calculation is performed to adjust the first chrominance value of the input pixel if the absolute value of each difference value is no larger than the noise threshold value; otherwise, the first chrominance value of the input pixel is remained if the absolute value of any difference value is larger than the noise threshold value, as described in Step S480. The first chrominance adjusting calculation is expressed as:
Cbin_new=(1−W3)×Cbin+W3×Cb_mean
wherein Cbin_new is an adjusted chrominance value of the input pixel, Cbin is the chrominance value of the input pixel, W3 is a weighting value and Cb_mean is a mean chrominance value of the neighboring pixels of the input pixel.

After either Step S470 or Step S480 is completed, another pixel is selected as a new input pixel, as described in Step S490.

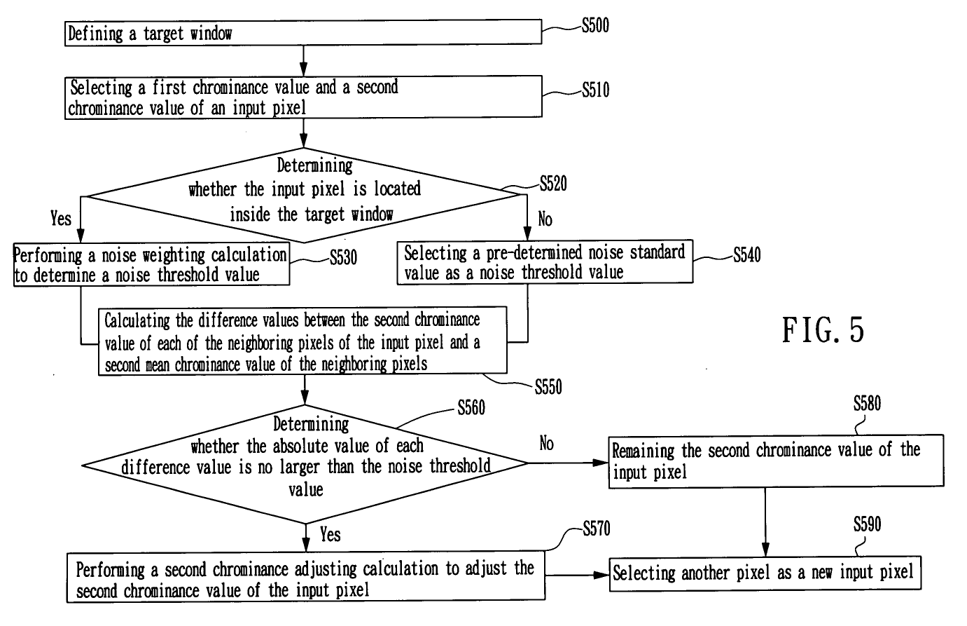

Please further refer to FIG. 5, which is a flowchart showing steps for adjusting the second chrominance value in the noise reduction method according to another preferred embodiment of the present invention. Step S500 to Step 540 are identical to Step S300 to Step 340. Step S550 to Step S580 are used for adjusting the second chrominance value, as described hereinafter.

In Step S550, the difference values between the second chrominance value of each of the neighboring pixels of the input pixel and a second mean chrominance value of the neighboring pixels are calculated so as to obtain a set of second chrominance difference values, as described in Step S550. In Step S560, whether the absolute value of each difference value is no larger than the noise threshold value is determining. In Step S570, a second chrominance adjusting calculation is performed to adjust the second chrominance value of the input pixel if the absolute value of each difference value is no larger than the noise threshold value; otherwise, the second chrominance value of the input pixel is remained if the absolute value of any difference value is larger than the noise threshold value, as described in Step S580. The second chrominance adjusting calculation is expressed as:
Crin_new=(1−W4)×Crin+W4×Cr_mean

wherein Crin_new is an adjusted chrominance value of the input pixel, Crin is the chrominance value of the input pixel, W4 is a weighting value and Cr_mean is a mean chrominance value of the neighboring pixels of the input pixel.

After either Step S570 or Step S580 is completed, another pixel is selected as a new input pixel, as described in Step S590.

The aforesaid weighting values W2, W3, W4 are selected according to a luminance index, a first chrominance index, a second chrominance index and a corresponding lookup table. The luminance index is expressed as:

$$\begin{matrix}Y\_index = abs [ Y 1 - Y\_mean ] + abs [ Y 2 - Y\_mean ] + \\ abs [ Y 3 - Y\_mean ] + abs [ Y 4 - Y\_mean ] + \\ abs [ Y 5 - Y\_mean ] + abs [ Y 6 - Y\_mean ] + \\ abs [ Y 7 - Y\_mean ] + abs [ Y 8 - Y\_mean ]\end{matrix}$$

wherein Y_index is the luminance index, Y1, Y2, Y3, Y4, Y5, Y6, Y7, Y8 are the luminance values of the neighboring pixels of the input pixel, and abs[] is an absolute value operator.

The first chrominance index is expressed as:

$$\begin{matrix}Cb\_index = abs [ Cb 1 - Cb\_mean ] + abs [ Cb 2 - Cb\_mean ] + \\ abs [ Cb 3 - Cb\_mean ] + abs [ Cb 4 - Cb\_mean ] + \\ abs [ Cb 5 - Cb\_mean ] + abs [ Cb 6 - Cb\_mean ] + \\ abs [ Cb 7 - Cb\_mean ] + abs [ Cb 8 - Cb\_mean ]\end{matrix}$$

wherein Cb_index is the first chrominance index, Cb1, Cb2, Cb3, Cb4, Cb5, Cb6, Cb7, Cb8 are the chrominance values of the neighboring pixels of the input pixel, and abs[] is an absolute value operator.

The second chrominance index is expressed as:

$$\begin{matrix}Cr\_index = abs [ Cr 1 - Cr\_mean ] + abs [ Cr 2 - Cr\_mean ] + \\ abs [ Cr 3 - Cr\_mean ] + abs [ Cr 4 - Cr\_mean ] + \\ abs [ Cr 5 - Cr\_mean ] + abs [ Cr 6 - Cr\_mean ] + \\ abs [ Cr 7 - Cr\_mean ] + abs [ Cr 8 - Cr\_mean ]\end{matrix}$$

wherein Cr_index is the second chrominance index, Cr1, Cr2, Cr3, Cr4, Cr5, Cr6, Cr7, Cr8 are the chrominance values of the neighboring pixels of the input pixel, and abs[] is an absolute value operator.

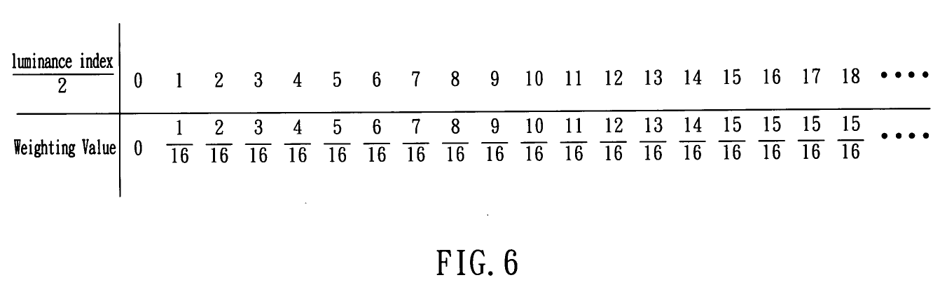

For example, in FIG. 6, when half of the luminance index is 2, W2 is set to be 2/16. Similarly, W3 and W4 can also be obtained by using the lookup table.

According to the above discussion, it is apparent that the present invention discloses a noise reduction method so as to identify noise in a digital image and adjust the luminance value and the chrominance values of a pixel that is determined a noise point so that the image quality is improved and the image distortion is avoided.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A noise reduction method for use in reducing noise of a digital image, the method comprising steps of:
defining a target window on a coordinate plane defined by the first chrominance and the second chrominance as the horizontal axis and the vertical axis;
determining a noise threshold value according to whether an input pixel having a first chrominance value and a second chrominance value is located inside the target window;
determining whether the input pixel is a noise point according to the noise threshold value and luminance values of neighboring pixels of the input pixel; and
adjusting a luminance value of the input pixel if the input pixel is determined a noise point.

2. The noise reduction method as recited in claim 1, wherein a noise weighting calculation is performed according to the shortest distance between the target window and the input pixel so as to determine the noise threshold value if the input pixel having the first chrominance value and the second chrominance value is located inside the target window.

3. The noise reduction method as recited in claim 2, wherein the noise weighting calculation is expressed as:
N_{—}th=N_{—}b−W1×Dmin
wherein N_th is the noise threshold value, N_b is a pre-determined noise standard value, W1 is a first weighting value and Dmin is the shortest distance between the target window and the input pixel.

4. The noise reduction method as recited in claim 1, wherein a pre-determined noise standard value is selected as the noise threshold value if the input pixel having the first chrominance value and the second chrominance value is located outside the target window.

5. The noise reduction method as recited in claim 1, wherein the step of determining whether the input pixel is a noise point comprises steps of:
obtaining a set of luminance difference values by calculating the difference values between the luminance value of each of the neighboring pixels of the input pixel and a mean luminance value of the neighboring pixels; and
determining whether the input pixel is a noise point based on the comparison between the absolute value of each of the luminance difference values and the noise threshold value.

6. The noise reduction method as recited in claim 1, wherein the step of adjusting the luminance value of the input pixel comprises a step of:
performing a luminance adjusting calculation so as to adjust the luminance value of the input pixel according to the luminance value of the input pixel and the mean luminance value of the neighboring pixels of the input pixel.

7. The noise reduction method as recited in claim 6, wherein the luminance adjusting calculation is expressed as:
Yin_new=(1−W2)×Yin+W2×Y_mean
wherein Yin_new is an adjusted luminance value of the input pixel, Yin is the luminance value of the input pixel, W2 is a second weighting value and Y_mean is a mean luminance value of the neighboring pixels of the input pixel.

8. The noise reduction method as recited in claim 7, wherein the second weighting value is selected from a lookup table.

9. A noise reduction method for use in reducing noise of a digital image, the method comprising steps of:
defining a target window on a coordinate plane defined by the first chrominance and the second chrominance as the horizontal axis and the vertical axis;
determining a noise threshold value according to whether an input pixel having a first chrominance value and a second chrominance value is located inside the target window;
determining whether the input pixel is a noise point according to the noise threshold value and color values of neighboring pixels of the input pixel; and
adjusting a color value of the input pixel if the input pixel is determined a noise point.

10. The noise reduction method as recited in claim 9, wherein a noise weighting calculation is performed according to the shortest distance between the target window and the input pixel so as to determine the noise threshold value if the input pixel having the first chrominance value and the second chrominance value is located inside the target window.

11. The noise reduction method as recited in claim 10, wherein the noise weighting calculation is expressed as:
N_{—}th=N_{—}b−W1×Dmin
wherein N_th is the noise threshold value, N_b is a pre-determined noise standard value, W1 is a first weighting value and Dmin is the shortest distance between the target window and the input pixel.

12. The noise reduction method as recited in claim 9, wherein a pre-determined noise standard value is selected as the noise threshold value if the input pixel having the first chrominance value and the second chrominance value is located outside the target window.

13. The noise reduction method as recited in claim 9, wherein the step of determining whether the input pixel is a noise point comprises steps of:
obtaining a set of color difference values by calculating the difference values between the color value of each of the neighboring pixels of the input pixel and a mean color value of the neighboring pixels; and
determining whether the input pixel is a noise point based on the comparison between the absolute value of each of the color difference values and the noise threshold value.

14. The noise reduction method as recited in claim 9, wherein the step of adjusting the color value of the input pixel comprises a step of:
performing a color adjusting calculation so as to adjust the color value of the input pixel according to the color value of the input pixel and the mean color value of the neighboring pixels of the input pixel.

15. The noise reduction method as recited in claim 14, wherein the color adjusting calculation is expressed as:
Cin_new=(1−W3)×Cin+W3×C_mean
wherein Cin_new is an adjusted color value of the input pixel, Cin is the color value of the input pixel, W3 is a third weighting value and C_mean is a mean color value of the neighboring pixels of the input pixel.

16. The noise reduction method as recited in claim 15, wherein the third weighting value is selected from a lookup table.

17. The noise reduction method as recited in claim 9, wherein the color value is the first chrominance value.

18. The noise reduction method as recited in claim 9, wherein the color value is the second chrominance value.
